(19) United States
(12) Patent Application Publication
(10) Pub. No.: US 2020/0210676 A1
(43) Pub. Date: Jul. 2, 2020

(54) COMPACT INTERVAL SWEEPING IMAGING SYSTEM AND METHOD

(71) Applicant: SIMPLEX MAPPING SOLUTIONS SB LTD., Herzliya (IL)

(72) Inventors: Shahar Barnea, Kiriat Ono (IL); Ziv Shragai, Herzliya (IL)

(73) Assignee: SIMPLEX MAPPING SOLUTIONS SB LTD., Herzliya (IL)

(21) Appl. No.: 16/233,146

(22) Filed: Dec. 27, 2018

(51) Int. Cl. G06K 9/00; B64D 47/08; B64C 39/02

(52) U.S. Cl. CPC G06K 9/0063; B64C 2201/127; B64C 39/024; B64D 47/08

(57) ABSTRACT

The present invention describes an aerial survey camera system. The system includes two or more cameras mounted on a bracket that rotates perpendicular to the aircraft's movement by a motor. The images are captured at specific calculated angular intervals during the camera's sweeps. The motor positions the cameras in the planned angles and stops their rotation, while the controller commands the cameras to capture the images. Optionally the aircraft crosses an area of interest in parallel lines of flight at opposite directions, for example to facility covering all viewing angles with a small number of cameras. The invention further discloses methods for efficient flight management utilizing the disclosed system.

### FIELD OF THE INVENTION

The present invention in some embodiments thereof is related to the field of survey systems more specifically but not exclusively, the invention is related to the field of aerial sweeping imaging systems and methods for capturing images from multiple angles.

### BACKGROUND

US Published Patent Application no. 20150022656 appears to disclose that, “A system for guided geospatial image capture, registration and 2D or 3D mosaicking, that employs automated imagery processing and cutting-edge airborne image mapping technologies for generation of geo-referenced Orthomosaics and Digital Elevation Models from aerial images obtained by UAVs and/or manned aircraft.”

U.S. Pat. No. 9,751,639 appears to disclose, “A camera triggering and aerial imaging mission visualization system. More specifically, a system that controls camera triggering, manages data from a positioning system and an attitude measuring device, and provides real-time image coverage and mission visualization in manned and unmanned aerial imaging applications. The system includes a control and data management device that interfaces with at least one camera; one or more positioning systems; one or more attitude measuring devices; one or more data transmission devices; and a mission visualization system. The aerial imaging system may be interfaced with a variety of commercial, off-the-shelf or custom cameras for use in aerial imaging on manned and unmanned aircrafts, and may also be used on other types of vehicles or for other applications.”

U.S. Pat. No. 8,717,418 appears to disclose that, “By defining an angular separation in a train of sequential images, and using an interlaced sequence of pairs of images matched by that defining angle, it is possible to create live 3D video from a single camera mounted on a remote vehicle as though in the in the immediate vicinity of the object being viewed. Such a camera can be mounted on a moving vehicle such as a plane or a satellite. In addition, computational power is provided to adaptively (and predictively) smooth out motion irregularities between these image pairs, so that smooth 3D video may be obtained. Continual feature-based correlation between successive frames allows corrections for various transformations so that there is a one-on-one correspondence in size, projection, orientation, etc. between matched frames, which enables capture and display of smooth 3D video.”

U.S. Pat. No. 7,509,241 appears to disclose, “A method and apparatus for automatically combining aerial images and oblique images to form a three-dimensional (3D) site model. The apparatus or method is supplied with aerial and oblique imagery. The imagery is processed to identify building boundaries and outlines as well as to produce a depth map. The building boundaries and the depth map may be combined to form a 3D plan view model or used separately as a 2D plan view model. The imagery and plan view model is further processed to determine roof models for the buildings in the scene. The result is a 3D site model having buildings represented rectangular boxes with accurately defined roof shapes.”

Midas-5 Manual 2010-2015 available from LEAD'AIR INC, 113 S. Hoagland Boulevard, KISSIMMEE Fla. 34741, TrackAir.com +1 (407) 343-7571 http ://trackair.com/wp-content/uploads/2015/10/MIDAS_5.pdf appears to disclose, “a rigid construction, specifically engineered for precise mounting of a single camera type. The cameras themselves are based on the highest resolution image platforms available on the professional market . . . In order to achieve this scientific-grade optical performance from these systems, the lens mounts must be replaced with a rigid assembly guaranteeing alignment and stability after final assembly. This is the Lead'Air “CAM-LENS” solution. The CAM-LENS mounting hardware then allows each imaging assembly to be precisely located in the oblique mounting jig, to form an indissociable array unit. The ruggedized optical mounts of each of the five cameras are permanently mounted together in precise alignment in a geometrically orthogonal array, machined to instrument standard precision . . . ”

US Published Patent Application no. 20100277587 appears to disclose, “Apparatus for capturing images while in motion, including at least one CCD camera housed within an aircraft traveling along a flight path, for capturing aerial images of ground terrain, a motor for rotating an axis on which the at least one CCD camera is mounted, and for generating a sweeping back-and-forth motion for a field of view of the at least one CCD camera, the sweeping motion being transverse to the aircraft flight path, and an optical assembly connected to said at least one CCD camera.”

US Published Patent Application no. US20170244880 appears to disclose, “An aerial camera system is disclosed that comprises at least one camera arranged to capture a plurality of successive images. Each camera including at least one respective image sensor, and the field of view of each camera is movable in a substantially transverse direction across a region of the ground. The system also includes a stabilization assembly associated with each camera that has at least one steering mirror. The steering mirror is controllably movable so as to translate the optical axis of the camera relative to the at least one image sensor in synchronization with image capture, so as to effect stabilization of an image on the at least one image sensor during image capture as the field of view of the camera moves in a substantially transverse direction across a region of the ground. The system is arranged to control the at least one camera to capture successive images at defined intervals as the field of view of the camera moves in a substantially transverse direction across a region of the ground.”

Additional background art includes U.S. Pat. Nos. 9,269,187, 8,723,953, 9,618,934 and U.S. Pat. No. 9,600,936, Chinese Utility Model CN203740138U, U.S. Pat. No. 5,999,211.

### SUMMARY OF THE INVENTION

According to an aspect of some embodiments of the invention, there is provided an imaging system for aerial 3D mapping including: at least two cameras; a bracket configured to hold the at least two cameras rigidly immobile with respect to each other at differing angles with respect to an axis; an actuator to sweep the bracket around the axis.

According to some embodiments of the invention, at least one of the at least two cameras is held by the bracket nadir at an angle of between 80 to 100 degrees to the axis.

According to some embodiments of the invention, a second of the at least two cameras is held at an oblique angle to the axis of between 15 to 75 degrees.

According to some embodiments of the invention, the at least two cameras is exactly two cameras.

According to some embodiments of the invention, the at least two cameras includes a third camera mounted to the bracket at an angle of between 15 to 75 degrees with respect to the axis in an opposite direction to the second camera.

According to some embodiments of the invention, the bracket further holds a lens of at least one of the at least two cameras immobile with respect to a body of the at least one camera.

According to some embodiments of the invention, the system further includes an aircraft and wherein the bracket is mounted to an underside of the aircraft.

According to some embodiments of the invention, the bracket is mounted to the aircraft with the axis parallel to a longitudinal axis of the aircraft.

According to some embodiments of the invention, the bracket holds one of the at least two cameras translated transversely with respect to another of the at least two cameras with respect to the axis.

According to an aspect of some embodiments of the invention, there is provided a method of imaging a region of interest including: traveling over the region along parallel lines of flight (LoF's) while taking images directed along the LoF's in only one of a forward or backwards oblique direction; sweeping a field of view FOV of the images transversely to form overlapping images from 6 oblique directions.

According to some embodiments of the invention, the method further includes: taking images in a nadir direction while passing on the LoF's to and sweeping the FOV of the images transversely to form overlapping images from 3 directions.

According to some embodiments of the invention, nadir direction is at an angle of between 80 to 100 degrees to the LoF's.

According to some embodiments of the invention, the oblique direction is at an angle of between 15 to 75 degrees to the LoF's.

According to some embodiments of the invention, the images are produced by exactly two cameras.

According to some embodiments of the invention, the method further includes: passing by each of two opposing sides of the region on the LoF's in each of two opposing directions.

According to an aspect of some embodiments of the invention, there is provided a method of imaging a region of interest including: traveling by each of two opposing sides of the region along parallel lines of flight (LoF's) while taking images directed along the LoF's in only one of a forward or backwards oblique direction; sweeping a field of view FOV of the images transversely to form overlapping images from 6 oblique directions.

According to some embodiments of the invention, the method further includes: taking images in a nadir direction while passing on the LoF's to and sweeping the FOV of the images transversely to form overlapping images from 3 directions.

According to some embodiments of the invention, nadir direction is at an angle of between 80 to 100 degrees to the LoF's.

According to some embodiments of the invention, the oblique direction is at an angle of between 15 to 75 degrees to the LoF's.

According to some embodiments of the invention, the images are produced by exactly two cameras.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 shows a perspective view of an example of a compact sweeping imaging system in accordance with an embodiment of the present invention;

FIG. 2 is a block diagram illustration of a mapping system in accordance with an embodiment of the present invention;

FIG. 3 is an exploded view of two imaging sensors enclosed in a bracket in accordance with an embodiment of the present invention;

FIG. 4 is a perspective view of a camera bracket and locker in accordance with an embodiment of the present invention;

FIG. 5 is a flow chart illustration of a method making images of a region of interest in accordance with an embodiment of the current invention;

FIG. 6 shows a schematic view of a servo motor and of a height adjustable plate in accordance with an embodiment of the present invention;

FIG. 7 shows a side view of the servo motor, camera bracket and the servo motor's bracket in accordance with an embodiment of the present invention;

FIG. 8 schematically shows two LoF's while surveying a region of interest in accordance with an embodiment of the present invention;

FIG. 9 schematically shows 5 different perspectives of nadir and oblique views obtained by a system in accordance with an embodiment of the present invention;

FIG. 10 schematically shows 9 different perspective views of an object on the ground obtained by a system in accordance with an embodiment of the present invention;

FIG. 11 schematically shows coverage of a single image captured of a portion of the area of interest in accordance with an embodiment of the present invention;

FIGS. 12A and 12B illustrate sweeps containing 4 images by each camera and the respective coverage between images in accordance with an embodiment of the present invention;

FIGS. 13A-D schematically show the coverage of a building through four passes on parallel LoF's across a RoI in accordance with an embodiment of the current invention;

FIG. 13E illustrates covering a RoI with multiple parallel LoF's on accordance with an embodiment of the current invention;

FIG. 13F illustrates covering a RoI with a flight path including multiple parallel LoF's on accordance with an embodiment of the current invention;

FIG. 13G illustrates overlapping FoVs of an oblique forward facing camera during multiple parallel LoF's on accordance with an embodiment of the current invention;

FIGS. 14A to and 14B illustrate two alternative mounting geometries for two cameras in accordance with embodiment of the current invention; and

FIGS. 15 to 20 illustrate an embodiment of a 3D aerial photomapping imaging system in accordance with an embodiment of the current invention.

### DETAILED DESCRIPTION OF THE INVENTION

For a better understanding of the invention and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention. From the description taken together with the drawings it will be apparent to those skilled in the art how the several forms of the invention may be embodied in practice. Moreover, it is to be understood that the phraseology and terminology employed herein is for the purpose of description and should not be regarded as limiting the scope of the invention hereof.

Some embodiments of the current invention may relate to the need for an imaging system, which is compact and lightweight to be easily integrated over various kinds of aircrafts including ultra-light weight aircrafts, Unattended Aerial Vehicles etc.

Some embodiments of the current invention may relate to the need for an imaging system in which the imaging sensors are not fixed in relation to the surface over which they are installed, to fine-tune the required imaging shooting angles during flight for obtaining the requested results while ensuring an efficient flight run.

An aspect of some embodiments of the current invention relates to a method of building a three-dimensional topography model using a two-cameras system and passing over the terrain over parallel paths. Optionally, the lines of sight of the two cameras are at a fixed angle one to another and/or are contained by a plane parallel to the path of travel. Optionally, the lines of sight of the cameras be swept along an angular path perpendicular to the line of travel. For example, while traveling along a line, the cameras may take pictures at many positions defining different angles of view of an object along the direction of travel. For example, the cameras may be swept along multiple angles to capture topography at multiple locations and/or different distances from the line of travel and/or at a different angle in a plane perpendicular to the LoF. For example, as pictures are made at different locations along different LoF's, each object may be photographed at a large number of different angles around each of two perpendicular axes.

An aspect of some embodiments of the current invention relates to a system of two cameras mounted at a fixed relation to each other on a swiveling frame. The frame optionally swivels around an axis. Optionally the 3 3D vectors defined by the two lines of sight of the two cameras and axis of swiveling fit into a single plane. In some embodiments, the system includes a processor configured to control the swiveling and/or the timing of picture taking by the cameras. For example, the processor may be configured to take pictures at multiple angles of swiveling. Optionally the system further includes an aerial platform and/or the frame is mounted on the aerial platform with the axis of swiveling parallel to a direction of flight of the platform. Optionally, the processor further controls the path of travel, for example to achieve a desired level of imaging coverage of area to capture images of every point in a region of interest at multiple angles from above and/or four directions and/or to map in three-dimensions the region and/or 3D features on the surface at a desired resolution from using an efficient flight path over the area in parallel flight lines.

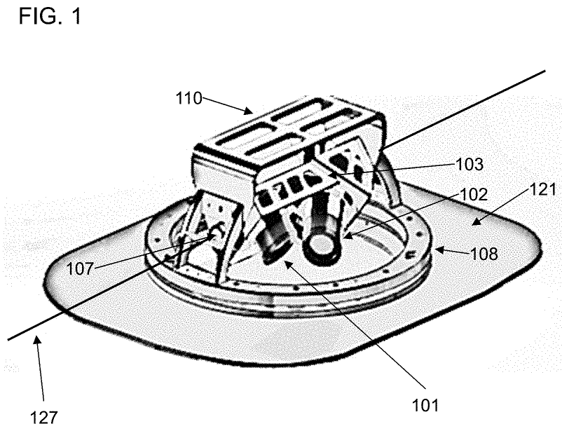

FIG. 1 shows a perspective view of an example of a compact sweeping imaging system according to the present invention. The exemplary system includes two rotating imaging sensors, which in this case include frame-based cameras 101, 102. The cameras are optionally mounted in a rigid frame 103.

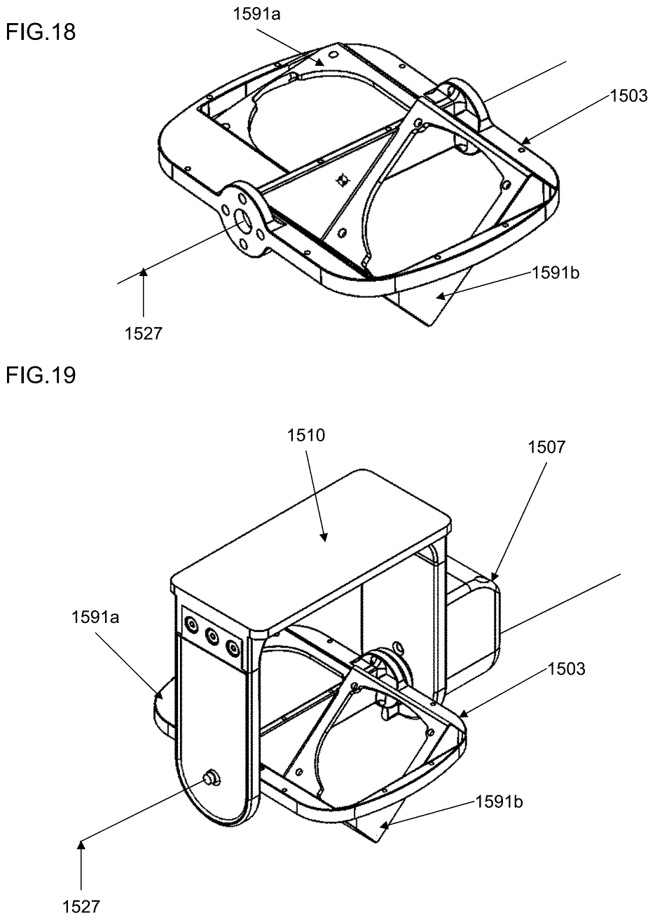

In some embodiments, the field of view of the cameras is optionally swept over a scene. For example, sweeping may include rotation of frame 103 around an axis 127. Optionally, the cameras 101, 102 are mounted with lines of site at different angles to the axis 127. For example, camera 101 is mounted with a line of which is perpendicular to the axis 127 while camera 102 is mounted with a line of sight at 45 degrees to the axis 127. Optionally, the line of sight of camera 101 and the line of sight of camera 102 and the axis 127 all fall in a single plane. Alternatively, the line of sight of camera 101 and the line of sight of camera 102 may each fall in a respective rotating plane (e.g. that the plane rotates as the line of sight is rotated around the axis) that is parallel to axis 127. Optionally the rotating plane of camera 101 is parallel to the rotating plane of camera 102 for example as illustrated in FIG. 14B.

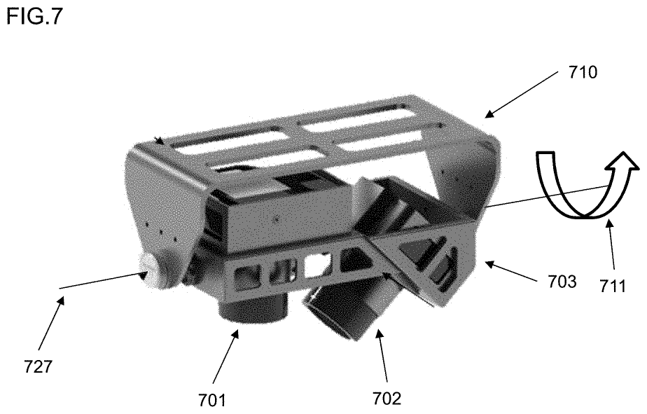

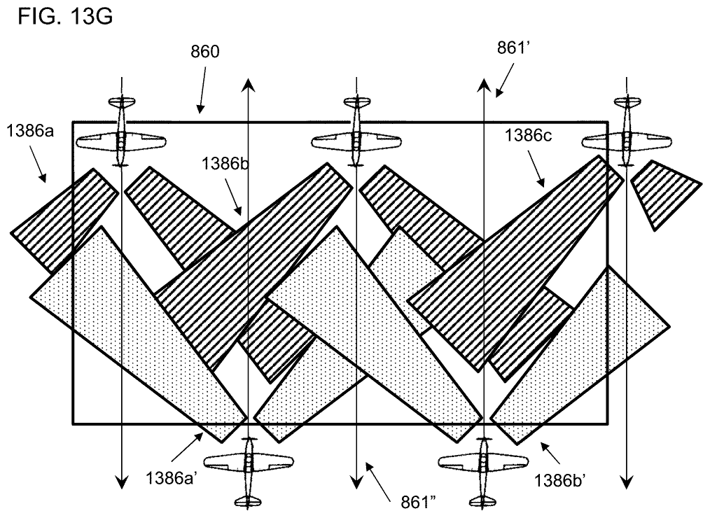

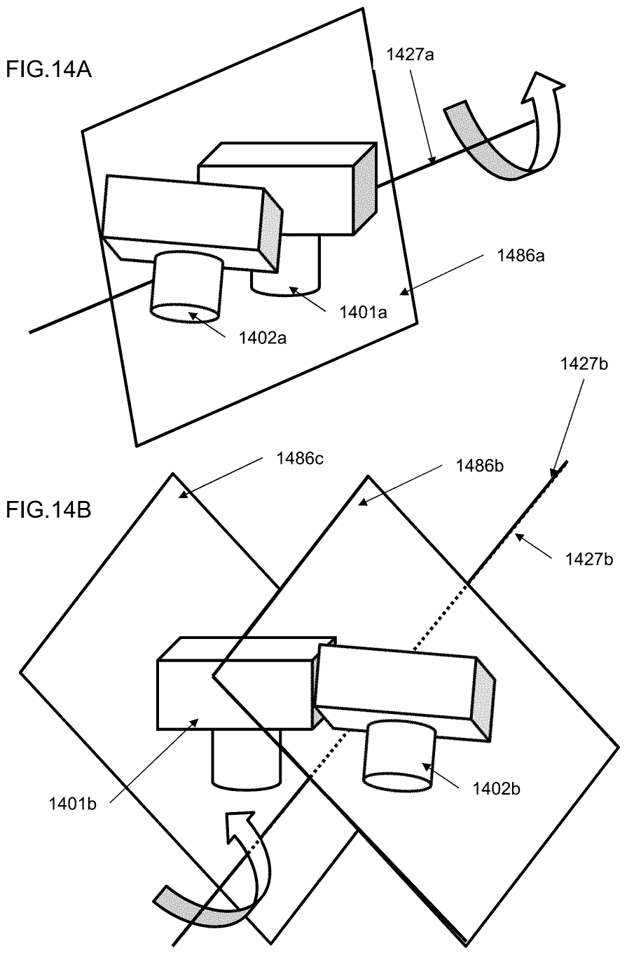

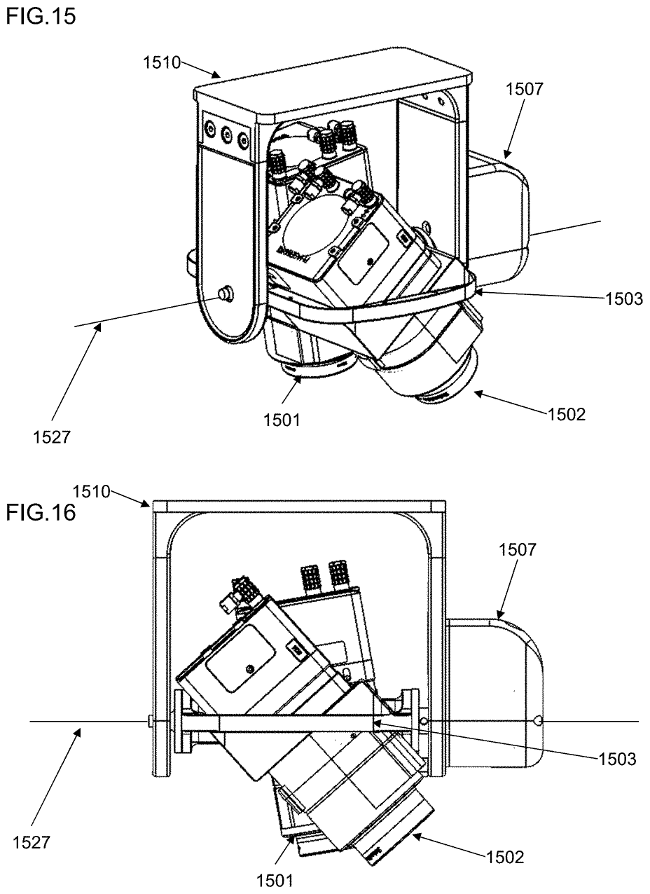

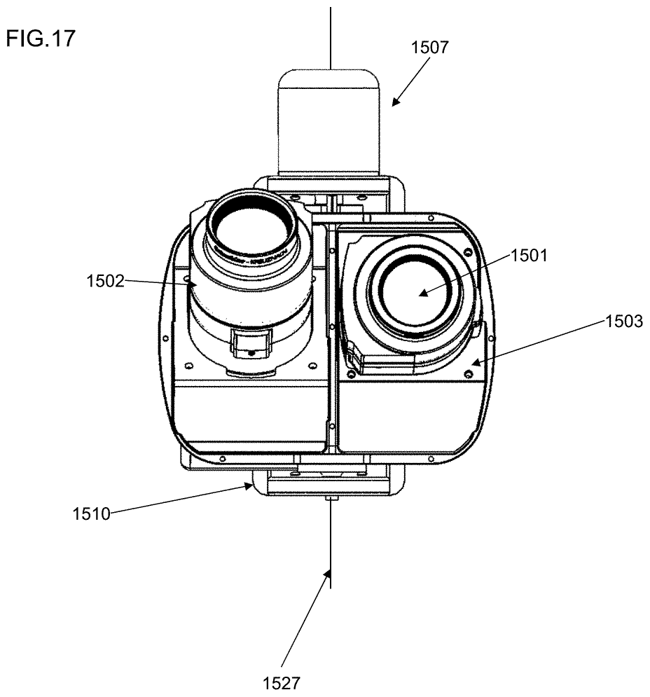

In some embodiments, rotation is driven by a motor 107 mounted onto a motor mount 110, for example as further depicted at FIG. 5. Alternatively or additionally, rotation may be driven by a DC motor and/or another actuator (for example a hydraulic actuator etc.) The angle of rotation of the cameras and/or the timing of each captured image are optionally controlled by the flight management computer. For example, the computer may adjust the angle and/or time and/or trajectory of the aircraft (e.g. speed and altitude) according to input of the area of interest which is to be covered and/or the resolution of the images which are to be obtained. In some embodiments, the flight management computer may provide an output including the flight lines which are to be followed, the height of the flight, the angle of rotation of the cameras (the extent of each sweep), the interval in which each image should be captured during the sweep (i.e., after how many degrees of rotation will an imaged be captured) and/or internal camera settings (for example resolution, zoom etc.). Optionally the motor is stopped in order to facilitate capturing a still image and/or after the still image is obtained the motor is reactivated to rotate the camera to the next calculated angle in order to capture the consecutive image. An example of a calculation to extract the flight protocol and system activation during its performance is shown in FIG. 13.

In some embodiments, the imaging system is installed on an aircraft's shooting hatch. Optionally, a stabilizer ring 108 dampens vibrations occurring from the aircraft's body and/or provides stability and/or facilitates improved image quality. Optionally, the stabilizer includes a connector to the aircraft and a shock absorber. For example, stabilizer 608 includes two metal plates separated by shock absorbers. Optionally, frame 103 is mounted to a lower surface 121 of an aircraft via ring 108. Optionally, a camera assembly may be placed on any of various locations on the underside of an aircraft. For example, the camera assembly may be place on a lower surface of the aircraft (for example a floor of a fuselage and/or a lower surface of a wing and/or a tail and/or a strut and/or the camera assembly may be mounted on a pod protruding from the aircraft.

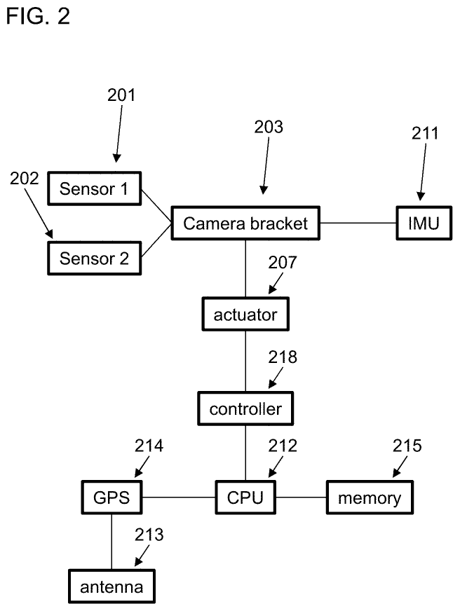

FIG. 2 is a schematic diagram illustrating some components of a system in accordance with an embodiment of the present invention:
Two sensors 201, 202 (e.g. cameras 101, 102 optionally including lenses and/or memory cards);
Actuator 207 (e.g. Servo and/or DC motor 107);
Navigation system 211 (e.g. INS (Internal navigation system) and/or GNSS (Global Navigation Satellite System with Antenna) and/or IMU (Inertial Measurement Unit);
Flight and/or sensor management computer 212.
GPS Antenna 213
GPS receiver 214
Flight Planning file 215
Motor controller 218

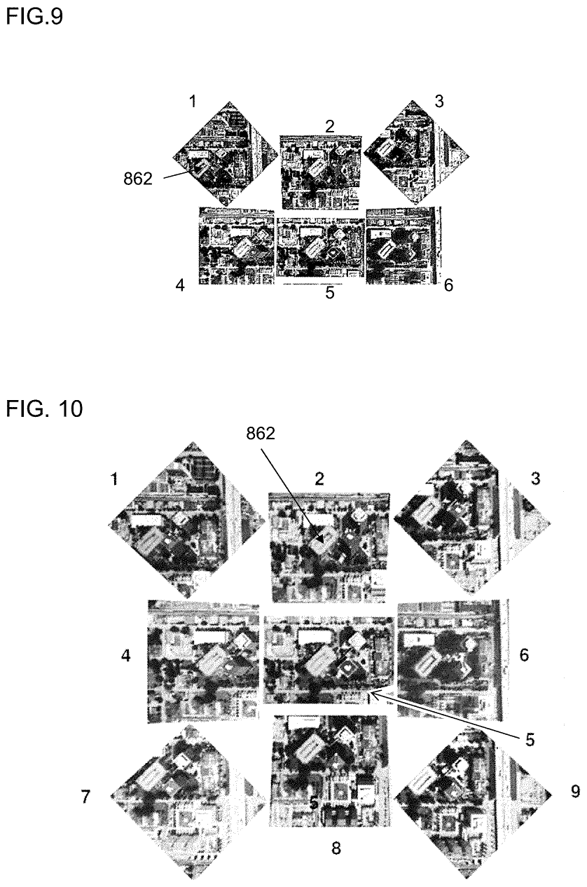

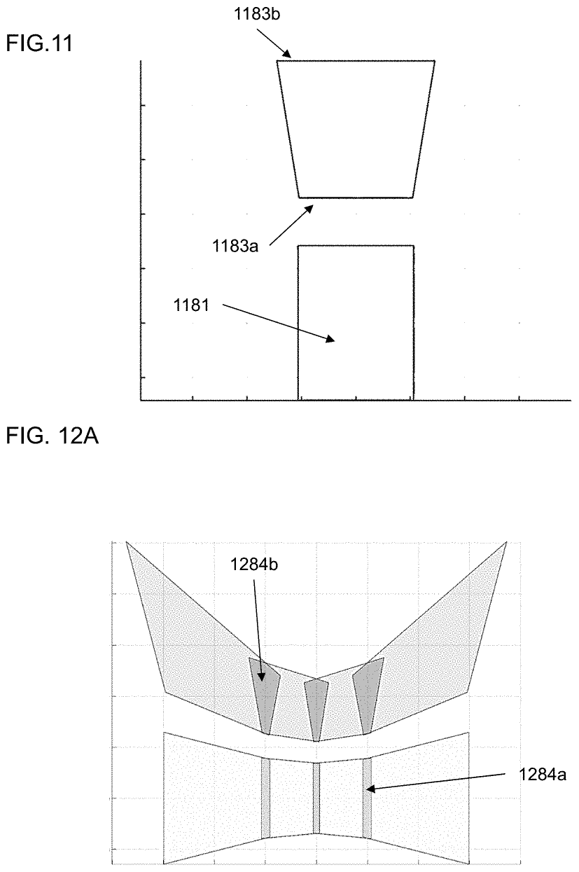

The system is connected to flight management computer 212 to execute the activation of the system according to the calculated flight procedure as described for example in FIG. 8. The system's control board receives the flight execution file 215 which contains, for example, the boundaries of the area of interest, the extracted flight lines, camera rotation angles (sweeps) and/or the intervals between sweeps in which images need to be captured. A GPS system provides the aircraft's position to the motor controller 218. According to the flight execution file 215, when the aircraft reaches the boundaries of the area of interest, the system switches to “operational mode”, in which the actuator 207 rotates the sensors 201, 202 according to the extracted interval sweeps. Optionally, after each interval of the sweep, the actuator 207 stops the cameras rotation to obtain a clear image and/or to reduce a smearing effect while an image is being taken. For example, after ensuring a complete stop, the controller gives the order to the camera to capture an image. The collected data (GPS data, angle data and/or images) is stored on a computer or on the camera's SD/compact-flash card. Optionally, each captured image is saved with a file name to enable construction of aerial maps and 3D mapping by software such as Accute3D (purchased by Bentley), PIX4D, Agisoft and SkyLine. In some embodiments the actuator 207 is connected to a bearing and to rotate the camera's back and forth, for example as displayed in FIG. 7A. The motor controller 218 is responsible for the actuator's 207 activation after it receives the command from the flight management computer 212.

For example, the commands may be synchronized with position, based on the GPS location data. In some embodiments, an actuator moves the camera to its position and/or waits for the camera to reach a full stop (for example it may wait a time ranging between 10 to 200 milliseconds and/or between 200 to 300 millisecond and/or between 200 to 800 milliseconds. For example, stopping may facilitate capturing the image when there is minimal camera movement (e.g. to prevent smearing effects). An IMU 211 is optionally installed on the camera bracket 203 and/or moves along with it. The IMU 211 optionally extracts the angles of each sensor 201, 202 when the images are being captured. The IMU 211 data is also stored on the flight management computer 212.

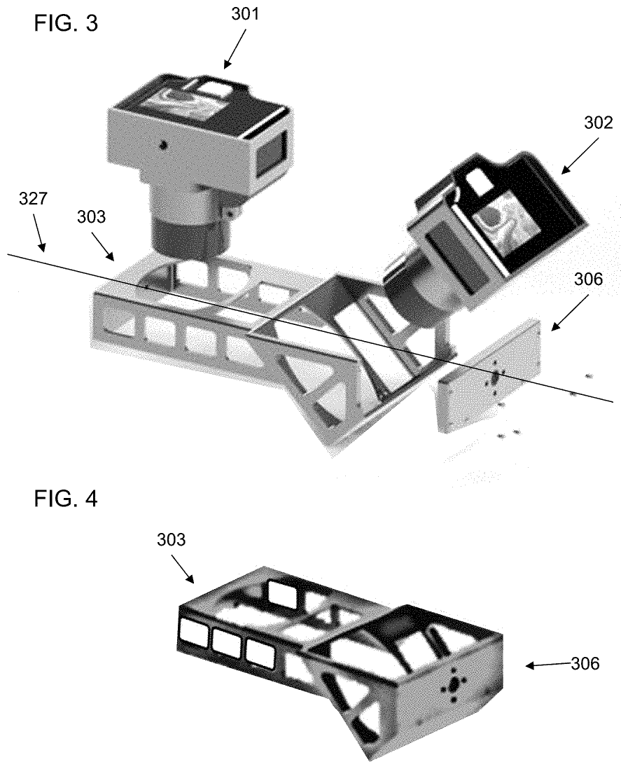

FIG. 3 illustrates two cameras 301, 302 and a camera bracket 303 in accordance with an embodiment of the current invention. Optionally, a bracket 203 tightly holds and/or locks the cameras 301, 302 and/or their lenses. For example, this may inhibit relative movement between the lenses and the cameras and/or relative movement between camera 301 and 302. In some embodiments, bracket 303 fixes the cameras 301, 302 in their perspective angles with respect to each other. For example, camera 301 is mounted at 90 degrees to an axis of rotation 327. Optionally, when the system is mounted on an aircraft, camera 301 is facing nadir (for example, in the in the lowest part of the sweep camera 301 may be facing vertically downward from a horizontally directed aircraft). Additionally or alternatively, the second camera 302 faces at a finite angle to axis 327. For example, in the embodiment of FIG. 3 camera 302 is directed at 45 degrees to the axis 327. Alternatively or additionally, a camera may be directed at an angle ranging, for example, between 40 to 50 degrees to the axis and/or between 30 to 40 degrees and/or between 10 to 30 degrees and/or between 50 to 80 degrees and/or between 0 to 10 degrees and/or between 80 to 90 degrees. Optionally, axis 327 may be mounted parallel to the longitudinal axis (roll axis) of the aircraft and/or camera 302 may be angled backwards and/or forward. Optionally, a locking member 306 bolts over camera 302 to hold it rigidly in bracket 303.

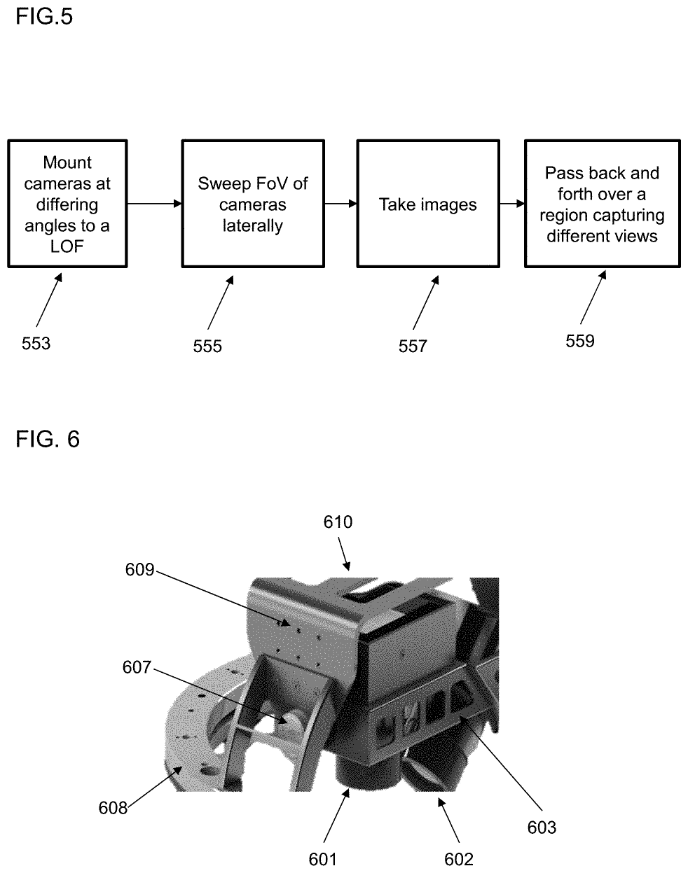

FIG. 4 illustrates the bracket 303 that secures the cameras and lenses in place in accordance with an embodiment if the current invention. The right space of the mount is designed to hold a camera at an oblique angle (e.g. 45 degrees), and the left space is designed to hold the vertical camera. The bracket is optionally made of aluminum. Optionally, bracket secures two cameras and their respective lens to prevent relative movement when the servo motor is rotating the bracket.

FIG. 5 is a flow chart illustration of a method of acquiring images for a 3D map. Optionally, two or more cameras are mounted 53 on an aircraft at different angles to a line of flight (LoF). For example, one camera may be mounted 553 approximately perpendicular to the LoF and the second camera may be mounted 553 at an oblique angle to the LoF. Optionally, the fields of view FoV's of the cameras are swept 555 laterally (e.g. transverse to the LoF). Optionally the FoVs of the cameras are synchronized. For example, the two cameras may be mounted in a bracket and/or moved simultaneously and/or a rotating mirror may sweep 555 the FoV's of two cameras together. Optionally while sweeping the cameras will take 557 images and/or particularly the camera that is mounted perpendicular to the LoF will capture images at various lateral angles of a region and/or the camera that is mounted oblique to line of flight will capture images of a first side of the scene over a first leg of the flight. Optionally the aircraft will pass 559 back in an opposite (and/or if not directly opposite at least opposing) direction.

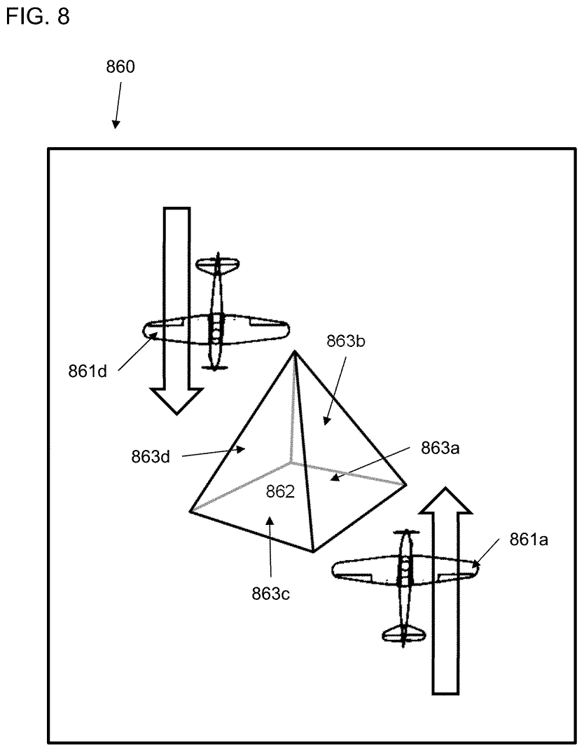

FIG. 6 discloses a motor 607 (for example a servo, a DC motor and/or a brushless motor) and a height adjustable plate 609 that enables various installations of the cameras above the aircraft's shooting hatch. A motor bracket 610 optionally pivotally connects (for example via an axial passing across sides of the camera bracket 603) to bracket. Bracket 603 optionally holds two cameras 601, 602. Optionally, motor 607, and/or a gear (i.e. Harmonic gear) and/or motor controller are housed next to the vertical camera's 601 end.

FIG. 7A is a perspective view of two cameras 701, 702 mounted on a camera bracket 703 optionally mounted on a motor bracket 710 in accordance with an embodiment of the current invention. The entire camera bracket 703 optionally rotates with respect to bracket 710. For example, bracket 703 rotates around axis 727 which corresponds to an axle of motor bracket 710 as is shown for example by the arrows 711.

FIG. 8. schematically shows two LoF's 861a, 861d while surveying a region of interest 860. LoF 861a is flown first, while LoF 861d is subsequently flown. LoF's 861a, 861b are optionally parallel. Optionally an aircraft crosses a region a few times while surveying, but does not need to cross the same location twice. For example, an aircraft crosses a region in series of parallel lines, in opposite directions, but does not need to return over then same line twice and/or does not return over the same point twice (for example does not need a cross pattern where the plane crosses previous lines of flight).

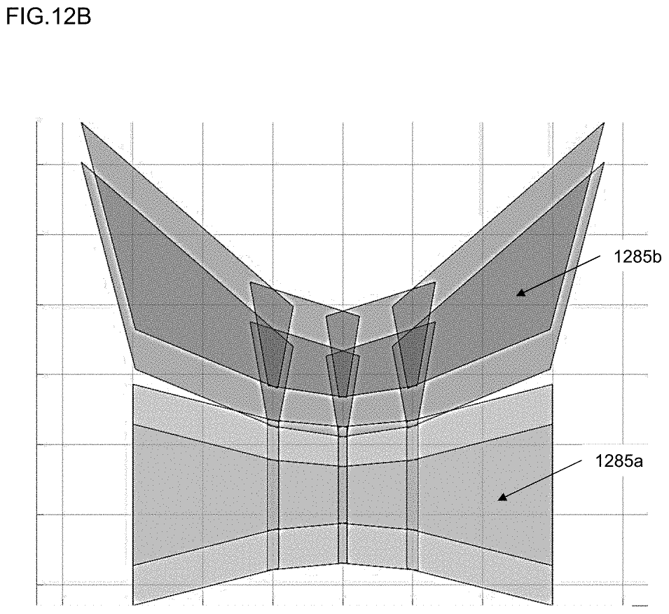

In some embodiments, the system only covers the nadir and forward views. Sweeping both cameras during a LoF in a single direction covers 3 oblique directions one side of the plane: (Right, forward, forward-right, and nadir) and/or 3 oblique directions on the opposite side of the plane: (Left, forward-left, and nadir) but not the three backward direction views. For example, while flying LoF 861a pictures will be taken of a front right face 863a of a building 862. In order to compensate that and to achieve 9 directions of view for each object in the region consecutive flight lines are optionally flown in opposite direction while the aircraft flies over the region on both sides of each feature. For example, in this embodiment, all 9 major views will be covered, using only two cameras. For example, face 863d is covered on LoF 861d. This will be further illustrated for example in FIGS. 9 and 10 and 13A-13D.

FIG. 9 schematically shows 5 different perspectives of oblique views obtained by a system in accordance with an embodiment of the current invention while traversing a LoF in one direction (i.e. LoF 861a heading “north”, as shown in FIG. 8). These views of are optionally achieved with the movement of two sweeping cameras, for example a forward camera and a nadir camera For example, three forward images (images: #1 #2 #3), that are being collected by the forward facing camera , and one vertical image (#5), and two additional views to the sides of the vertical image (images #4 and #6), that are being collected by the nadir camera.

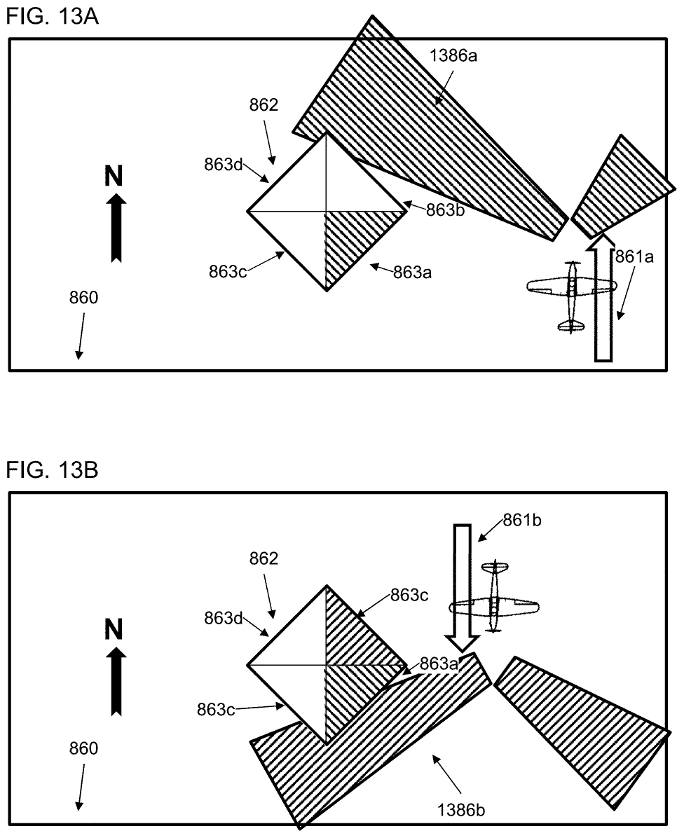

FIG. 10 schematically shows 9 different perspective views of objects on the ground obtained by a system in accordance with an embodiment of the current invention. After the completion of LoF 861d, which is flown to the opposite direction of LoF 861a (e.g. First LoF 861a is flown “Northward” and then the next LoF 861d is being flown “Southward”, as shown for example in FIG. 8), 9 directions of views are achieved. In some embodiments, for example for a two-camera configuration with one camera nadir and one camera facing obliquely forward, to get all 9 views of any one object one would optionally pass back and forth in opposite direction on each of two sides of the objects. Alternatively or additionally, for an embodiment having at least one camera obliquely forward and one cameral obliquely backward (for example two oblique cameras and/or three cameras [two oblique and one nadir]) one would optionally cover all 9 views of an object passing once on one side and once on the opposite side. Either way, all 9 views of the zone would be achieved crossing the region on a back and forth flight path without crossing the same point more than once. E

FIG. 10 shows how 3 additional views (images #7, #8 and #9) are being collected by the forward camera when the aircraft passes over flight line 861d. Due to the 75% overlap between flight lines 861a and 861d, 8 oblique views (images #1, #2, #3, #4, #6, #8 and #9) are collected by cameras 1 and 2 in parallel, plus one vertical image (image #5) that is collected by camera #1. Optionally, overlap may range between 65% to 85% and/or 40% to 65% and/or between 10% to 40% and/or between 85% to 95%.

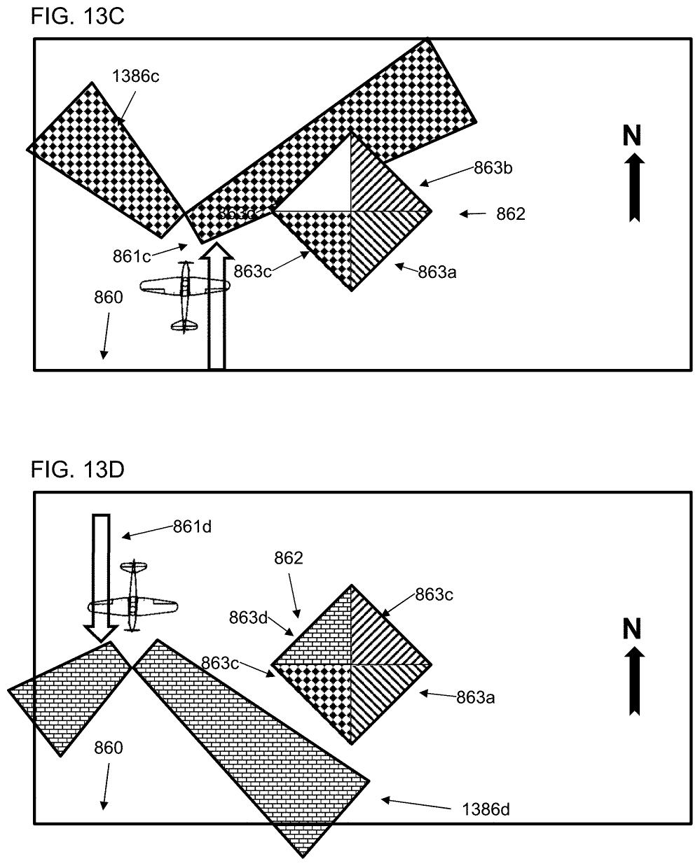

FIG. 11 schematically shows the coverage of a single image captured by each of the two cameras of a portion of the area of interest (one nadir and one in 45 degrees forward oblique). For example, using the dimensions and sensor size of two Cannon SDSR cameras, 50 MP, with 50 mm focal length lens (for the nadir camera) and 85 mm focal length lens (for the forward oblique camera), a coverage of 100×100 M is achieved on the ground for the nadir view 1181. A ground resolution of 2 cm is achieved for Nadir and between 1.45 cm at the near end 1183a to 2 cm at the far end 1183b for the forward oblique view.

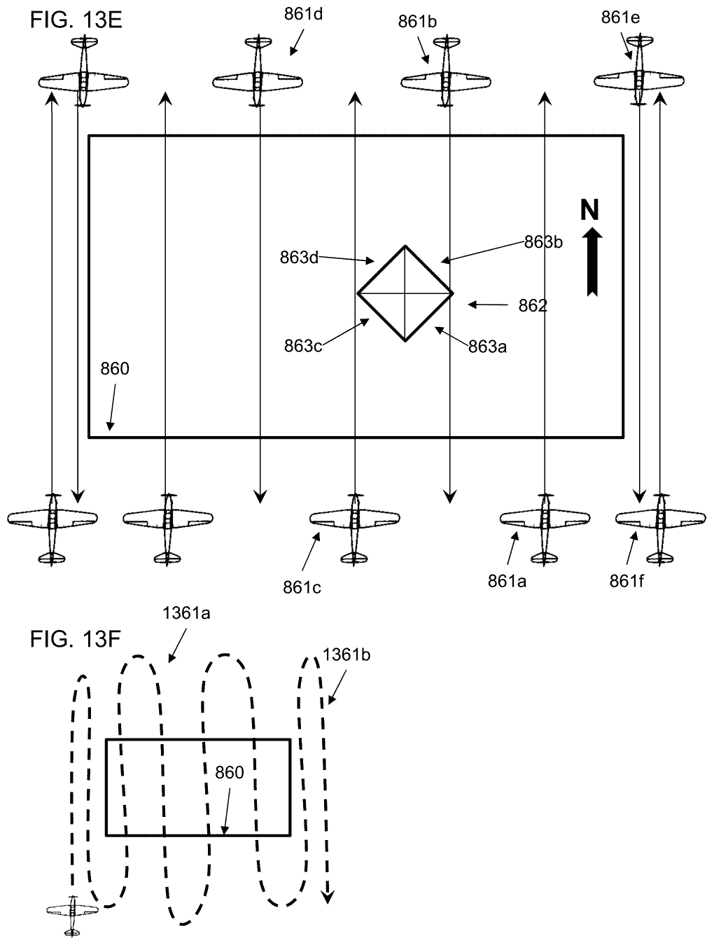

FIG. 12A displays a sweep containing 4 images for each of a nadir and an oblique mounted camera in accordance with an embodiment of the current invention. Alternatively or additionally, a sweep may include between 2 to 4 images and/or between 4 to 8 images and/or between 8 to 20 images. With the same exemplary camera and lenses as described in the description of FIG. 11. The footprint coverage achieved on the ground is 734 M for the nadir. Optionally, there is an overlap 1284a and 1284b of 20% between the images for the Nadir and oblique mounted cameras respectively in the sweep. Alternatively or additionally, an overlap within a sweep may range between 10% to 30% and/or 0 to 10% and/or 30% to 50% and/or 60% to 90%.

FIG. 12B schematically shows the respective coverage of two consecutive sweeps containing 4 images each. There is 55% overlap 1285a, 1285b between the sweeps of the nadir and obliquely mounted cameras respectively.

In an exemplary embodiment with the same cameras and lenses as described above with respect to FIGS. 11 and 12, coverage for example at 2 cm GSD (Ground Sample Distance) may include:
Foot print coverage: 734 m.
Distance between flight lines for orthophoto creation: 158 m.
Field of view: 113 degrees.
Views on an object: 9 different angles.

In some embodiments, the motor stops every 21 degrees to take one image inside a sweep. Alternatively or additionally, the stops may range between 15 to 25 degrees and/or between 5 to 15 degrees and/or between 25 to 45 degrees.

For example, the collective coverage may include:
Overlap between images in a sweep: 20%
Overlap between images between sweeps inside a single flight line: 55% \textcircled{}Overlap between different flight lines: 75%
Flight lines collection sequence: fly adjacent flight lines in opposite directions.

In some embodiments, overlap between different flight lines may range for example, between 70 to 80% and/or between 50 to 70% and/or between 70 to 90% and/or between 20 to 50%.

For mission planning the system inputs for example Google earth KML file that bound the area of interest. The planning routine optionally automatically determines the flight lines according to input such as: lens focal length, flight altitude, terrain, speed of the aircraft, and/or resolution requirements. The planning file optionally includes the start point and/or end point of LoF so that it will provide coverage for the region of interest, for example as marked on Google earth. The automatic algorithm optionally calculates the required distances between lines, length of lines, flight altitude, and exact location of each line.

An example of a calculation to extract the flight management file and system activation during its performance could be:

Terms and fixed figures used in the calculation:
Camera—Canon 5DS-R with 50 mm lens (as described in the system)
Forward Overlap(%)=FO (55)
Side Overlap(%): SO (30)
Flying Speed(Knots): FS(90)
Maximal Angle for Ortho(Deg): MAO(18)
Focal length(mm): F (50)
Resolution Width(pixels): RW(8688)
Resolution Height(Pixels): RH(5792)
Pixel Size(mm): PS(0.00414)
Calculations:

$$Sensor Dimension X ( mm ) - SDX = RW * PS ( 36.0 )$$

$$Sensor Dimension Y ( mm ) - SDY = RH * PS ( 24.0 )$$

$$Field Of View X ( deg ) \text{:} FOVX = 2 * {tan}^{- 1} ( \frac{SDX}{2 * F} ) = 39.60$$

$$Field Of View Y ( deg ) \text{:} FOVY = 2 * {tan}^{- 1} ( \frac{SDY}{2 * F} ) = 26.99$$

$$Ground Sampling Distance \text{:} G S D ( m ) = G S D ( 0.1 )$$

$$Computations$$

$$Flying Altitude ( m ) - A = G S D * \frac{F}{p s} = ( 1206 ) \\ Image Coverage X ( m ) - ICX = RW * G S D = ( 868.8 ) \\ Image Coverage Y ( m ) - ICY = RH * G S D = ( 579.2 ) \\ Distance Between Frames ( m ) - DBF = ICX * ( 1 - FO / 100 ) = ( 390.96 ) \\ Distance Between Lines ( m ) ( Without Sweeping ) - ICY * ( 1 - SO / 100 ) = ( 405.44 ) \\ Time Between Frames ( or “ Cycle Time ” in sweeping mode ) - CT ( sec ) = \frac{DBF * 3.6}{FS * 1.952} = ( 8.44 )$$

$$Sweeping$$

$$No . of Image In Sweep - NIS = ( 5 )$$

$$In Sweep Overlap ( \% ) - ISO = ( 20 )$$

$$Sweep Angular Coverage - SAC = \{ NIS - ( NIS - 1 ) * \frac{ISO}{100} \} * FOVY = 113.37 \\ Sweep Step ( deg ) - SS = ( 1 - \frac{ISO}{100} ) * FOVY = ( 21.59 ) \\ Sweep Coverage ( m ) = 2 * FA * tan ( SAC / 2 ) = 3671.50 Total Sweep Unique Pixels = \{ NIS - ( NIS - 1 ) * \frac{ISO}{100} \} * RH = 24326.4 \\ Tilt of first and last image in sweep = \frac{NIS - 1}{2} * SS = 43.19 \\ Distance Between Lines ( m ) = 2 * tan MAO * FA = 784.13$$

FIGS. 13A-13D are schematic illustrations of coverage various faces of a building 862 in four lines of flight in accordance with an embodiment of the current invention. In some embodiments all faces of an object may be imaged by passing the object on parallel LoF. For, example, in an embodiment with one oblique camera (for example forward) and one nadir camera, all 9 directions may be coved by four LoF. For example, one LoF in each of two opposite direction passing by each of two opposite sides of the object. Each of the four LoF's adds another face to the imaging collection.

For illustrative purposes building 862 is illustrated a s pyramid, dependent on the altitude and slope angle, a sloped face of a pyramid may be seen from the air even from opposite sides. The description herein may apply to for example to a rectangular building having vertical walls directed at 45 degrees to the LoF of the surveying aircraft and/or to surfaces on more complex structures that are oriented in various directions.

FIG. 13A illustrates passing building 862 on a first LoF 861a in a first direction. An oblique forward facing camera captures a field of view FoV illustrated by 1386a. As the plane passes the East side of building 862, for example along a North-South LoF in a direction from South to North, with the oblique forward facing camera taking overlapping pictures, the South-East face 863a will be imaged. On the other hand, faces which face North (e.g. face 863c) and/or West (e.g. 863c and 863d) may not get properly covered (e.g. images may not include these faces and/or the views of these faces may be at high angles wherein some features (e.g. sunken features and/or features angled away from the camera) will be hard to discern.

FIG. 13B illustrates passing building 862 on a second LoF 861b in on the same side as LoF 861a in an opposite direction. An oblique forward facing camera captures a FoV illustrated by 1386b. As the plane passes the East side of building 862, for example along a North-South LoF in a direction from North to South with the oblique forward facing camera taking overlapping pictures, the North-East face 863b will be imaged. On the other hand, faces which face South (e.g. face 863a) and/or West (e.g. 863c and 863d) may not get properly covered (e.g. images may not include these faces and/or the views of these faces may be at high angles wherein some features (e.g. sunken features and/or features angled away from the camera) will be hard to discern. For example, after passing in opposite directions on LoF's 1386a and 1386b faces 863a and 863b have been covered while faces 863c and 863d have not been properly covered.

FIG. 13C illustrates passing building 862 on a third LoF 861c in an opposite side thereof with respect to LoF's 861a and 861b and in the same direction as 861a. An oblique forward facing camera captures a FoV illustrated by 1386b. As the plane passes the West side of building 862, for example along a North-South LoF in a direction from South to North with the oblique forward facing camera taking overlapping pictures, the South-West face 863c will be imaged. On the other hand, faces which face North (e.g. face 863d) and/or East (e.g. 863a and 863b) may not get properly covered (e.g. images may not include these faces and/or the views of these faces may be at high angles wherein some features (e.g. sunken features and/or features angled away from the camera) will be hard to discern. For example, after three passes on LoF's 1386a, 1386b and 1386c faces 863a and 863b and 863c have been covered while face 863d has not been properly covered.

FIG. 13D illustrates passing building 862 on a fourth LoF 861d in on the same side as LoF 861c in an opposite direction. An oblique forward facing camera captures a FoV illustrated by 1386d. As the plane passes the West side of building 862, for example along a North-South LoF in a direction from North to South with the oblique forward facing camera taking overlapping pictures, the North-West face 863b will be imaged. On the other hand, faces which face South (e.g. face 863c) and/or East (e.g. 863a and 863b) may not get properly covered (e.g. images may not include these faces and/or the views of these faces may be at high angles wherein some features (e.g. sunken features and/or features angled away from the camera) will be hard to discern. For example, after passing building 862 on four LoF's 1386a and 1386b and 1386c and 1386d, faces 863a and 863b and 863c and 863d have all been properly covered.

FIG. 13E illustrates covering a RoI with multiple parallel LoF's on accordance with an embodiment of the current invention. Optionally an aircraft passes back and forth across a region of interest 860 on parallel LoF's (e.g. LoF's 861a-861d). Additionally or alternatively, the aircraft may pass each side back and forth on parallel LoF's (e.g. LoF's 861e-861f). On each LoF the aircraft optionally covers objects on either side of the aircraft from one oblique point of view. For example, on one South to North directed path a forward pointing camera covers objects on the left side of the aircraft from the South East and/or objects on the right side of the aircraft from the South West. As the aircraft passes back from North to South a forward pointing camera covers objects on the left side of the aircraft from the North West and/or objects on the right side of the aircraft from the North East. Additionally or alternatively, a nadir mounted camera may catch view directly down and/or a side view (e.g. East and/or West). Optionally as the aircraft passes over the region on multiple passes, each object is photographed from all nine directions.

FIG. 13F illustrates covering a RoI 860 with a flight path 1361a, 1361b including multiple parallel LoF's on accordance with an embodiment of the current invention. A flight path 1361a may loop around back and forth across the RoI 860 on adjacent lines on each subsequent pass and/or the flight path may make larger loops skipping adjacent paths and/or filling in on subsequent passes. Optionally, path 1361a continues to path 1361b with at least two passes 1361b past a side of the RoI 860, for example to catch objects on near the edge of the RoI 860 from the that side.

FIG. 13G illustrates overlapping FoV's of an oblique forward facing camera during multiple parallel LoF's on accordance with an embodiment of the current invention. Optionally, as an aircraft passes back on LoF's 861′ back and LoF's forth 861″, sweeps of an oblique (e.g. forward facing) camera 1386a-1386c and/or 1386a′-1386b′ overlap and capture all 9 views of each object in the RoI from multiple distances and/or angles.

FIGS. 14A to and 14B illustrate two alternative mounting geometries for two cameras in accordance with embodiment of the current invention. For example, in the geometry of FIG. 14A, a line of sight Loss of a nadir mounted camera 1401a and a LOS of an obliquely mounted camera 1402a and a rotational axis 1427a are coplanar (all being included for example in plane 1486a). Optionally, camera 1401a is translated axially (e.g. along the direction of axis 1427a) with respect to camera 1402a. In contrast in the embodiment of FIG. 14B, nadir mounted camera 1401b is transversely translated with respect to oblique mounted camera 1402b. Optionally, the Loss of cameras 1401b and 1402b fall on separate parallel planes 1486b and 1486c. Alternatively or additionally as the cameras 1401b and 1402b are rotated around axis 1427b, the Loss of the cameras remain in the parallel planes 1486b and 1486c which rotate together around axis 1427b.

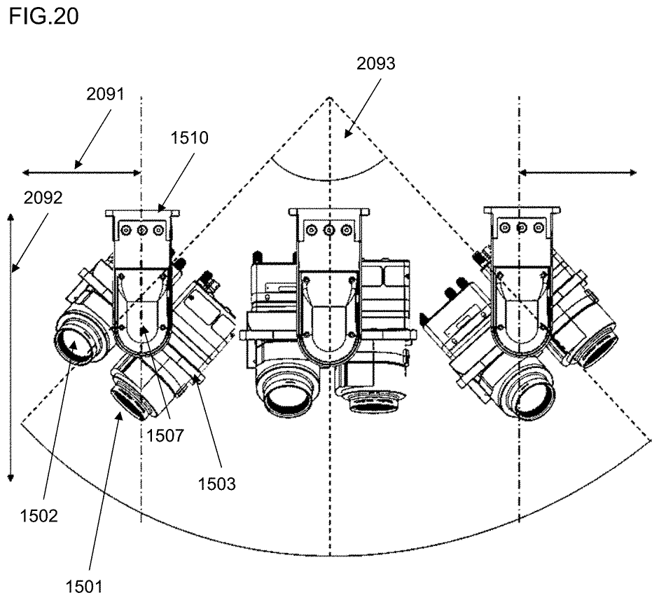

FIGS. 15 to 20 illustrate an embodiment of a 3D aerial photomapping imaging system in accordance with an embodiment of the current invention. In some embodiments, a 3D photomapping imaging system includes two cameras 1501, 1502 rotating sweeping around an axis 1527 wherein the cameras' LoS's and/or the axis 1527 of rotation are not is not coplanar. For example, the cameras may be translated from each other on a transverse line (e.g. perpendicular to the axis of rotation). In some embodiments, transversal mounting of the camera may make it possible to produce a small system. Optionally, camera 1501 is mounted nadir nearly and/or exactly perpendicular to the axis of rotation 1527. For example, camera 1501 may be mounted at an angle ranging between 0 to 5 degrees to axis 1527 and/or between 5 to 15 degrees. Optionally, camera 1502 is mounted at a higher angle to axis 1527 for example ranging between 15 to 35 degrees and/or between 35 to 55 degrees and/or between 55 to 75 degrees to axis 1527.

In some embodiments, cameras 1501 and 1502 are mounted on a mounting bracket 1503. For example, bracket 1503 may include a nadir mount 1591a for a nadir camera 1501 and/or an oblique mount 1591b for an oblique camera 1502. Optionally, bracket 1503 is rotationally attached to a motor (i.e. DC or Servo) bracket 1510 and/or rotation of bracket 1503 with respect to bracket 1510 around an axis 1527 is driven by a motor 1507. The nadir mount 1591a is optionally configured to hold a camera at a small angle to axis 1527 when compared to oblique mount 1591b. For example, mount 1591a may hold a camera at an angle ranging between 0 to 5 degrees to axis 1527 and/or between 5 to 15 degrees. Optionally, mount 1591b may hold a camera at an angle ranging between 15 to 35 degrees and/or between 35 to 55 degrees and/or between 55 to 75 degrees to axis 1527.

FIG. 20 illustrates three states of rotation of camera bracket 1503 with respect to servo bracket 1510. For example, bracket 1503 may rotate to an angle 2093 ranging between 0 to 15 degrees and/or between 0 to 30 degrees and/or between 0 to 45 degrees and/or between 0 to 60 degrees and/or between 0 to 80 degrees. Additionally or alternatively, rotation may include rotation in an opposite direction (e.g. negative angles). For example, bracket 1503 may rotate to an angle 2093 ranging between 0 to −15 degrees and/or between 0 to −30 degrees and/or between 0 to −45 degrees and/or between 0 to 60 degrees and/or between 0 to −80 degrees. Optionally, the system may rotate over the same range in both directions. Alternatively or additionally, a system may rotate more in one direction than another. In some embodiments, a system may have a third camera. For example, a second oblique camera may be set up mounted tilting in an opposite direction from the first oblique camera (for example one backwards and the other forward).

Optionally with the third camera the overlap of FOV's for adjacent LoF may be less than with only one oblique camera and/or the range of rotation may be less and/or the system may rotate only in one direction.

Optionally a vertical length 2092 of the imaging system perpendicular to axis 1527 may range between 50 to 150 mm and/or between 150 to 350 mm and/or between 350 to 500 mm. Optionally a horizontal width 2091 of the imaging system perpendicular to axis 1527 may range between 25 to 75 mm and/or between 75 to 175 mm and/or between 175 to 250 mm.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the specification.

It is expected that during the life of a patent maturing from this application many relevant technologies will be developed and the scope of the terms is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An imaging system for aerial 3D mapping comprising:
at least two cameras;
a bracket configured to hold said at least two cameras rigidly immobile with respect to each other at differing angles with respect to an axis;
an actuator to sweep said bracket around said axis.

2. The system of claim 1, wherein at least one of said at least two cameras is held by said bracket nadir at an angle of between 80 to 100 degrees to said axis.

3. The system of claim 2, wherein a second of said at least two cameras is held at an oblique angle to said axis of between 15 to 75 degrees.

4. The system of claim 3, wherein said at least two cameras is exactly two cameras.

5. The system of claim 3, wherein said at least two cameras includes a third camera mounted to said bracket at an angle of between 15 to 75 degrees with respect to said axis in an opposite direction to said second camera.

6. The system of claim 1, wherein said bracket further holds a lens of at least one of said at least two cameras immobile with respect to a body of said at least one camera.

7. The system of claim 1, further comprising an aircraft and wherein said bracket is mounted to an underside of said aircraft.

8. The system of claim 7, wherein said bracket is mounted to said aircraft with said axis parallel to a longitudinal axis of the aircraft.

9. The system of claim 1, wherein said bracket holds one of said at least two cameras translated transversely with respect to another of said at least two cameras with respect to said axis.

10. A method of imaging a region of interest comprising:
traveling over said region along parallel lines of flight (LoF's) while taking images directed along the LoF's in only one of a forward or backwards oblique direction;
sweeping a field of view FOV of said images transversely to form overlapping images from 6 oblique directions.

11. The method of claim 10, further comprising:
taking images in a nadir direction while passing on said LoF's to and sweeping the FOV of said images transversely to form overlapping images from 3 directions.

12. The method of claim 11, wherein nadir direction is at an angle of between 80 to 100 degrees to said LoF's.

13. The method of claim 10, wherein said oblique direction is at an angle of between 15 to 75 degrees to said LoF's.

14. The method of claim 11, wherein said images are produced by exactly two cameras.

15. The method of claim 10, further comprising:
passing by each of two opposing sides of the region on said LoF's in each of two opposing directions.

16. A method of imaging a region of interest comprising:
traveling by each of two opposing sides of the region along parallel lines of flight (LoF's) while taking images directed along the LoF's in only one of a forward or backwards oblique direction;
sweeping a field of view FOV of said images transversely to form overlapping images from 6 oblique directions.

17. The method of claim 16, further comprising:
taking images in a nadir direction while passing on said LoF's to and sweeping the FOV of said images transversely to form overlapping images from 3 directions.

18. The method of claim 17, wherein nadir direction is at an angle of between 80 to 100 degrees to said LoF's.

19. The method of claim 16, wherein said oblique direction is at an angle of between 15 to 75 degrees to said LoF's.

20. The method of claim 17, wherein said images are produced by exactly two cameras.
